(19) United States
(12) Patent Application Publication
(10) Pub. No.: US 2025/0118043 A1
(43) Pub. Date: Apr. 10, 2025

(54) A METHOD FOR DETECTING DEAD INSECTS AND AN ARRANGEMENT FOR IMPLEMENTING THIS METHOD

(71) Applicant: "PROTEINE RESOURCES" SPÓLKA Z OGRANICZONA ODPOWIEDZIALNOSCIA, Maslomiaca (PL)

(72) Inventor: KONRAD WLODARCZYK, Maslomiaca (PL)

(73) Assignee: "PROTEINE RESOURCES" SPÓLKA Z OGRANICZONA ODPOWIEDZIALNOSCIA, Maslomiaca (PL)

(21) Appl. No.: 18/836,356

(22) PCT Filed: Feb. 7, 2022
(86) PCT No.: PCT/PL2022/050005

§ 371 Date: Aug. 7, 2024

(51) Int. Cl. G06V 10/145; G06V 40/10

(52) U.S. Cl. CPC G06V 10/145; G06V 40/10; G06V 2201/06

(57) ABSTRACT

A method for detecting dead insects, including fragments thereof, characterised in that the insects are placed in the range of a UV radiation source (1) and in the field of vision of an image recording device (2) connected to a computer (3), and the image of insects subjected to UV radiation is recorded by means of the image recording device (2), and subsequently the image acquired in such a way is analysed in order to identify noticeably brighter objects. The application also relates to an arrangement for detecting dead insects according to this method.

The object of the invention is a method for detecting dead insects, including fragments thereof, for use in particular in the breeding, farming or treatment of insects, and an arrangement for implementing this method.

Breeding and farming of insects on an industrial scale is one of the most dynamically developing methods for acquiring alternative animal protein. However, for its development, it is necessary to lower the high costs of manually operating the farming, in particular to be able to identify dead specimens. Automation and robotisation of the processes of breeding, farming and treatment of insects is the key to obtaining profitability allowing for competition with previous methods of acquiring protein for food and feed uses, so destructive for the ecosystem of our planet. The use of machine learning algorithms and the application of artificial intelligence to control and optimise production processes in the breeding, farming and treatment of insects requires providing sufficient quantity and quality of data from visual systems, replacing organoleptic assessment of a caretaker during manual operation. To this end, it is possible to use an image of insects generated under the influence of ultraviolet radiation.

The phenomenon of luminescence of organisms has been known to man for hundreds of years. Already in the ancient times, Aristotle and Pliny the Elder wondered about the source of light which was possible to observe among certain dead fish and in rotted wood [Biron K.: Fireflies, dead fish and a glowing bunny: a primer on bioluminescence. BioTeach J., 2003; 1: 19-26].

There is a known phenomenon of bioluminescence among live insects, caused by luciferase occurring in a beetle of the species Photinus pyralispyralis [Luker K. E., Luker G. D.: Applications of bioluminescence imaging to antiviral research and therapy: multiple luciferase enzymes and quantitation. Antiviral Res., 2008; 78: 179187]. Its presence was also proven in some species of the families Lampiridae, Elateridae and Phengodidae [Stevani C. V., Oliveira A. G., Mendes L. F., Ventura F. F., Waldenmaier H. E., Carvalho R. P., Pereira T. A.: Current status of research on fungal bioluminescence: biochemistry and prospects for ecotoxicological application. Photochem. Photobiol., 2013; 89: 1318-1326].

There is also a known phenomenon of fluorescence of certain organisms, meaning the emission of light due to a triggering stimulus. One example is the fluorescence of scorpions under the influence of ultraviolet radiation. In this case, the result is emission of light close to a green-blue colour. The fluorescence is caused by beta-carboline and 7-hydroxy-4-methylcoumarin present in the outer layer of chitin.

Insects in industrial production are usually separated according to stages of growth and sizes, and kept in mono groups of high density. In the event of occurrence of unpreferable environmental conditions or the appearance of a pathogen, mortality occurs in waves, starting from individual specimens, and subsequently spreading onto their increasing number until the extinction of a whole group, meaning all specimens from a single farming container. With an adequately high ratio of dead specimens, even withdrawal of the lethal factor causes death of whole farming groups. This is why adequately early detection of first dead specimens is of key significance, enabling adequately early response identifying and correcting unpreferable factors causing mortality. Stopping the process often saves the entire production from dying in its entirety.

Although it is extremely complicated, dead insects in a larval form can be identified by means of visual systems detecting motion. However, in the case of species or stages of development where motion is minimal (e.g. pupae), detection of dead specimens in this way is not possible, or it takes too much time to be used efficiently in a continuous production process. In such a case, the only remaining way is to visually assess the changing appearance of a dead specimen, e.g. a change in the colour and/or shape due to the processes of decomposition/drying. However, depending on the species and environmental conditions, the appearance of the first signs of these processes takes place even up to 7 days after dying, during which the whole group usually becomes infected and it is already too late to implement remediation processes.

Therefore, it is the purpose of the invention to develop a method for detecting dead insects allowing for the earliest possible detection of dead specimens before the occurrence of changes visible in white light. This is because it unexpectedly turned out that the use of ultraviolet radiation of varying wavelength enables precise detection of dead insects several days before the appearance of any symptoms enabling the detection of this phenomenon in another way, although neither the phenomenon of fluorescence of dead insects nor the phenomenon of reflecting light by dead specimens had not been known before.

The object of the invention is a method for detecting dead insects, including fragments thereof, characterised in that the insects are placed in the range of a UV radiation source and in the field of vision of an image recording device connected to a computer, and the image of insects subjected to UV radiation is recorded by means of the image recording device, and subsequently the image acquired in such a way is analysed in order to identify noticeably brighter objects which constitute dead specimens.

Preferably, the wavelength of UV radiation ranges from 365 nm to 395 nm.

Preferably, the insects are insects from the order Coleoptera.

Preferably, the insects are insects of the species Tenebrio molitor, Alphitobius diaperinus or Zophobas morio.

Preferably, the insects are in various stages of growth.

Preferably, the image recording device is a digital camcorder or a digital camera.

Preferably, the analysis of the image is performed by means of a computer provided with computer software provided with machine learning algorithms.

The object of the invention is also an arrangement for detecting dead insects comprising the UV radiation source and the image recording device connected to the computer equipped with a screen, and a transport line for transporting containers with the insects, the operation of the UV radiation source, the camcorder and the transport line being synchronised and controlled electronically by means of the computer.

Preferably, the image recording device is a digital camcorder or a digital camera.

Preferably, the computer is provided with computer software provided with machine learning algorithms.

Preferably, the UV radiation source and the image recording device are integrated in a single device.

The method according to the invention can be implemented using both simple manual devices during manual operation, as well as advanced illuminators in robotised technological lines. The use of ultraviolet radiation to detect dead specimens each time enables their identification earlier than by means of organoleptic methods or other visual systems.

An embodiment of the object of the invention is presented in a drawing, in which:

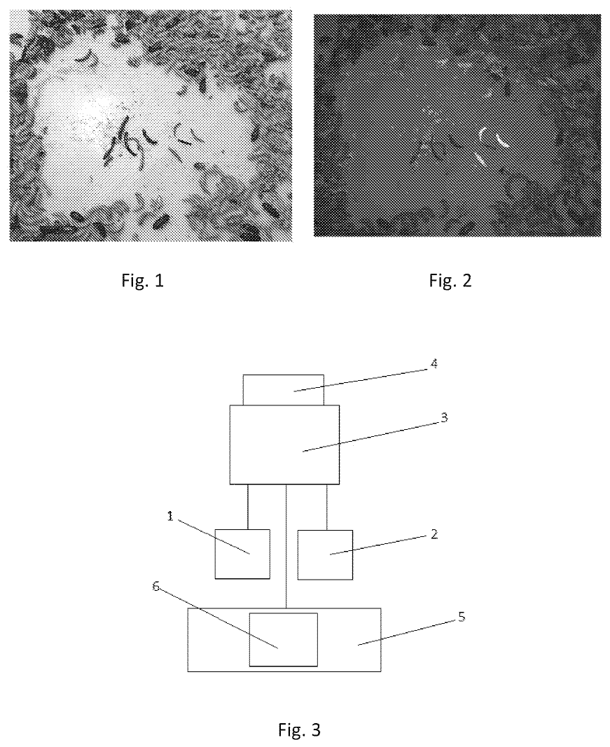

FIG. 1 constitutes a white light photograph of the insects, in which dead specimens cannot be distinguished;

FIG. 2 constitutes a UV light photograph in which noticeably brighter objects constituting dead specimens are visible;

FIG. 3 presents a general schematic of the arrangement for detecting dead insects;

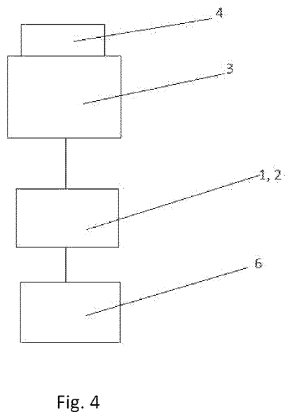

FIG. 4 presents a general schematic of the arrangement for detecting dead insects, in which the image recording device is presented integrated with the UV light source.

### EXAMPLE 1

A farming container 6 comprising pupae of species A. diaperinus during its metamorphosis into the imago form was placed in a farming rack, and the container 6 was situated in the field of vision of an image recording device 2 in the form of a photographic camera and within the range of a UV radiation source 1. During the next six days, the insects placed in the container 6 were subjected to UV radiation, and at the same time photographs were taken. The photographs of this container 6 were also taken in white light. On the first day, reflection of UV rays by a single object was observed, which turned out to be a single dead pupa, and in the following days the number of objects reflecting UV radiation increased—these objects were identified as further dead specimens. It was observed that the ability to reflect light by dead specimens initially increased, and subsequently decreased starting on the fifth day. On the sixth day, an image not showing objects reflecting UV light was acquired. At the same time, on the same day the results of the occurring advanced decomposition processes were already visible in white light.

Unexpectedly, it turned out that the creation of a bright image of dead specimens under the influence of UV radiation occurs with various degrees of intensity at different wavelengths, but the effects are already achieved with commonly used UV365 nm and UV395 nm. The observed phenomenon occurred several hours after dying (in the case of an insect, it is difficult to precisely determine the moment of termination of life processes) and continued until the occurrence of changes in appearance resulting from the decomposition process. It was taken into account that, under the conditions of high humidity, the decomposition processes cause a change in the colour of dead specimens in white light, with a minor change in shape. In low humidity environment, a change in the colour of drying dead specimens is minor, while the shape undergoes considerable correction. It was observed that the phenomenon created under the influence of UV radiation occurred regardless of the level of humidity and temperature of the environment, from the moment of death until the appearance of sings of decomposition or drying of dead specimens.

### EXAMPLE 2

A farming container 6 with insects of the species Tenebrio molitor in various stages of growth was subjected to the process of screening. Upon mechanical separation of insects from undigested food and frass, white light, and subsequently UV light with a wavelength of 395 nm, were directed at a selected area in the central part of the container 6, in which there were specimens in a larval stage. On the display of the image recording device 2, an image was acquired on which it was possible to distinguish objects noticeably reflecting UV light, upon which these objects were analysed. This analysis indicated that three objects noticeably reflecting UV radiation were dead specimens, in which the signs of decomposition processes visible in white light had not yet been shown. One specimen was damaged mechanically in the separation process.

### EXAMPLE 3

A farming substrate in the form of wheat bran was placed in a Petri dish along with randomly selected specimens of the species Tenebrio molitor in the stage of metamorphosis. The dish was subjected to the impact of white light, and subsequently UV radiation with wavelengths of 365 nm and 395 nm. The image was acquired by the image recording device 2 in the form of a digital camera. On the display of the computer 4, it was clearly visible that some of the specimens noticeably reflected UV radiation with wavelengths of 365 and 395 nm, and some did not. After a detailed analysis of all specimens, it was concluded that the objects reflecting UV light were dead pupae, and objects which did not reflect it were larval forms in an advanced stage of decomposition, moults and a single specimen of a live pupa.

### EXAMPLE 4

A farming container 6 with insects from the order Coleoptera was placed on a transport line 5, upon which the tested farming container 6 was immobilised in the field of vision of a camcorder 2 connected to a computer 3, and in the range of a UV radiation source 1. Subsequently, the UV radiation source 1 was activated, emitting radiation with a wavelength of 365 nm directed at the farming container 6. Subsequently, the image from the camcorder 2 was observed on the display 4 of the computer 3, and it was subjected to processing using computer software interpreting the brightness of areas. Noticeably brighter areas were observed on the image from the camcorder 2, due to which this container 6 was removed from the transport line 5, and the specimens constituting brighter areas were removed from it manually, upon which it was concluded that these specimens were dead.

### EXAMPLE 5

A farming container 6 with insects of the species Zophobas morio was placed on a transport line 5, upon which the tested farming container 6 was immobilised in the field of vision of a camcorder 2 connected to a computer 3, and in the range of a UV radiation source 1. Subsequently, the UV radiation source 1 was activated, emitting radiation with a wavelength of 395 nm directed at the farming container 6. Subsequently, the image from the camcorder 2 was observed on the display 4 of the computer 3, and it was subjected to processing using computer software interpreting the brightness of areas. Noticeably brighter areas were observed on the image from the camcorder 2, due to which this container 6 was removed from the transport line 5, and the specimens constituting brighter areas were removed from it manually, upon which it was concluded that these specimens were dead.

As presented in the attached drawing in FIG. 13, the arrangement for detecting dead insects comprises a UV radiation source 1 and a camcorder 2 connected to a computer 3 equipped with a screen 4 and provided with computer software interpreting the brightness of areas, preferably based on machine learning algorithms. The UV radiation source 1 and the camcorder 2 can be integrated in a single device, as presented in FIG. 14. The arrangement for detecting dead specimens can be connected to a transport line 5, along which the containers 6 with the insects are transported. Preferably, the operation of the UV radiation source 1, the camcorder 2 as well as the transport line 5 is synchronised and controlled electronically by means of the computer 3.

The use of UV radiation in visual systems conveying information to machine learning algorithms and artificial intelligence results in elevating them to a previously unobtainable level, i.e. allowing not only for equalisation of the efficiency and complexity of analysis with the human factor, but also for surpassing the latter. Due to the use of computer software based on machine learning algorithms, including those created based on learning neural networks, it is possible to precisely determine the time of death of insects based on the intensity of reflecting ultraviolet radiation.

The method according to the invention can be found useful in particular in the breeding and farming as well as treatment of insects. Early detection of dead specimens and their immediate elimination from further treatment is critical for the quality and safety of the whole product batch. The method according to the invention is basically the only method for early detection of such specimens. It is also an extremely efficient and cheap method, possible to apply to production lines with any transport speed of the product.

The method according to the invention can also be used to detect dead specimens and/or fragments thereof in frass. Depending on the applied frass separation technology, insects can be damaged in this process, with their fragments or whole dead specimens penetrating the end product. The possibility of their quick identification directly in the frass treatment line is of key significance for the efficiency and safety of production.

Moreover, the method according to the invention also works perfectly in detecting first signs of cannibalism, both among larvae and adult specimens, as well as at one of the most critical moments of the life cycle of insects, in the metamorphosis period, when larvae intensively looking for nutrients damage fresh pupae. Adequately early detection of the cannibalism phenomenon enables supplementing feeding stuffs with proper ingredients serving its elimination.

1. A method for detecting dead insects, including fragments thereof, characterised in that the insects are placed in the range of a UV radiation source (1) and in the field of vision of an image recording device (2) connected to a computer (3), and the image of insects subjected to UV radiation is recorded by means of the image recording device (2), and subsequently the image acquired in such a way is analysed in order to identify noticeably brighter objects.

2. The method according to claim 1, characterised in that the wavelength of UV radiation ranges from 365 nm to 395 nm.

3. The method according to claim 1, characterised in that the insects are insects from the order Coleoptera.

4. The method according to claim 3, characterised in that the insects are insects of the species Tenebrio molitor, Alphitobius diaperinus or Zophobas morio.

5. The method according to claim 1, characterised in that the insects are in various stages of growth.

6. The method according to claim 1, characterised in that the image recording device (2) is a digital camcorder or a digital camera.

7. The method according to claim 1, characterised in that the analysis of the image is performed by means of the computer (3) provided with computer software provided with machine learning algorithms.

8. An arrangement for detecting dead insects according to claim 1, characterised in that it comprises the UV radiation source (1) and the image recording device (2) connected to the computer (3) equipped with a screen (4), and a transport line (5) for transporting containers (6) with the insects, the operation of the UV radiation source (1), the camcorder (2) and the transport line (5) being synchronised and controlled electronically by means of the computer (3).

9. The arrangement according to claim 8, characterised in that the image recording device (2) is a digital camcorder or a digital camera.

10. The arrangement according to claim 8, characterised in that the computer (3) is provided with computer software provided with machine learning algorithms.

11. The arrangement according to claim 8, characterised in that the UV radiation source (1) and the image recording device (2) are integrated in a single device.
